(19) United States
(12) Patent Application Publication
(10) Pub. No.: US 2024/0001510 A1
(43) Pub. Date: Jan. 4, 2024

(54) METHOD AND APPARATUS WITH VENTING OR EXTRACTION OF TRANSPORT FLUID FROM BLAST STREAM

(71) Applicant: Cold Jet, LLC, Loveland, OH (US)

(72) Inventor: Daniel Mallaley, Loveland, OH (US)

(21) Appl. No.: 18/215,999

(22) Filed: Jun. 29, 2023

Related U.S. Application Data
(60) Provisional application No. 63/358,057, filed on Jul. 1, 2022.

(51) Int. Cl. B24C 7/00; B24C 1/00

(52) U.S. Cl. CPC B24C 7/0046; B24C 1/003

(57) ABSTRACT

A method and apparatus entrain particles in a flow of blast fluid from a flow of transport fluid with particles entrained therein, in which an effectual amount of the transport fluid is vented or extracted prior to the entrainment of the particles in the flow of blast fluid.

### PRIORITY

This application claims priority to U.S. Provisional Patent Application Ser. No. 63/358,057, filed Jul. 1, 2022, entitled “Method and Apparatus with Venting or Extraction of Transport Fluid from Blast Stream,” the disclosure of which is incorporated by reference herein.

### BACKGROUND

Particle blast systems utilizing various types of blast media are well known. Systems for entraining cryogenic particles, such as solid carbon dioxide particles, in a transport fluid and for directing the entrained particles toward objects/targets are well known, as are the various component parts associated therewith, such as nozzles, and are shown in U.S. Pat. Nos. 4,744,181, 4,843,770, 5,018,667, 5,050,805, 5,071,289, 5,188,151, 5,249,426, 5,288,028, 5,473,903, 5,520,572, 6,024,304, 6,042,458, 6,346,035, 6,524,172, 6,695,679, 6,695,685, 6,726,549, 6,739,529, 6,824,450, 7,112,120, 7,950,984, 8,187,057, 8,277,288, 8,869,551, 9,095,956, 9,592,586, 9,931,639, 10,315,862 and 10,737,890 all of which and their disclosures are incorporated herein in their entirety by reference.

Additionally, all of the following applications and their disclosures are incorporated herein in their entirety by reference: U.S. patent application Ser. No. 11/853,194, filed Sep. 11, 2007, for Particle Blast System With Synchronized Feeder and Particle Generator US Pub. No. 2009/0093196; U.S. Provisional Patent Application Ser. No. 61/589,551 filed Jan. 23, 2012, for Method And Apparatus For Sizing Carbon Dioxide Particles; U.S. Provisional Patent Application Ser. No. 61/592,313 filed Jan. 30, 2012, for Method And Apparatus For Dispensing Carbon Dioxide Particles; U.S. patent application Ser. No. 13/475,454, filed May 18, 2012, for Method And Apparatus For Forming Carbon Dioxide Pellets; U.S. patent application Ser. No. 14/062,118 filed Oct. 24, 2013 for Apparatus Including At Least An Impeller Or Diverter And For Dispensing Carbon Dioxide Particles And Method Of Use US Pub. No. 2014/0110510; U.S. patent application Ser. No. 14/516,125, filed Oct. 16, 2014, for Method And Apparatus For Forming Solid Carbon Dioxide US Pub. No. 2015/0166350; U.S. patent application Ser. No. 15/297,967, filed Oct. 19, 2016, for Blast Media Comminutor US Pub. No. 2017/0106500; U.S. patent application Ser. No. 15/961,321, filed Apr. 24, 2018 for Particle Blast Apparatus US Pub. No. 2019/0321942; U.S. Provisional Patent Application Ser. No. 62/890,044, filed Aug. 21, 2019, for Particle Blast Apparatus and Method; U.S. patent application Ser. No. 16/999,633, filed Aug. 21, 2020 for Particle Blast Apparatus and Method US Pub. No. 2021/0053187; U.S. Provisional Patent Application Ser. No. 62/955,893, filed Dec. 31, 2019, for Method and Apparatus For Enhanced Blast Stream; U.S. patent application Ser. No. 17/139,292, filed Dec. 31, 2020, for Method and Apparatus For Enhanced Blast Stream, US Pub. No. 2021/0197337; U.S. Provisional Patent Application Ser. No. 63/185,467, filed May 7, 2021, for Method and Apparatus for Forming Solid Carbon Dioxide; and U.S. patent application Ser. No. 17/738,389, filed May 6, 2022, for Method and Apparatus for Forming Solid Carbon Dioxide.

Also well-known are particle blast apparatuses which entrain non-cryogenic blast media, such as but not limited to abrasive blast media. Examples of abrasive blast media include, without limitation, silicon carbide, aluminum oxide, glass beads, crushed glass and plastic. Abrasive blast media can be more aggressive than dry ice media, and its use preferable in some situations.

Mixed media blasting is also known, in which more than one type of media is entrained within a flow which is directed toward a target. In one form of mixed media blasting, dry ice particles and abrasive media are entrained in a single flow and directed toward a target.

Many factors affect the ultimate performance of the flow of entrained particles exiting the blast nozzle of the particle blast system and impacting a target. The kinetic energy of the particles at impact on the target plays a significant role in the efficacy of the flow of entrained particles in achieving a desired result, such as decontaminating various types of surfaces, altering the properties of various type of surfaces or separating constituent parts (e.g., inter alia, removing layers of coatings or contaminants from substrates).

Typical prior art systems which utilize cryogenic particles transport the particles entrained in a flow of transport fluid, typically air. In some systems, the particles are entrained in the flow of transport fluid by a particle feeder, which introduces the particles into the transport fluid, and carried via a delivery hose to a blast nozzle for expulsion therefrom. In these systems, the transport fluid must have sufficient kinetic energy to convey the particles from the feeder, through the delivery hose to the blast nozzle. The transport fluid must have sufficient energy to discharge the particles out of the blast nozzle, whether the flow be subsonic, sonic or supersonic, and reach the target.

In other systems, the particles are entrained in a transport fluid and carried through a hose to a mixing nozzle at which the flow of particles entrained in the transport fluid is combined with a flow of blast fluid, typically via a venturi, and expelled out a blast nozzle. In such systems, the transport fluid must have sufficient energy to convey the particles to the venturi with the blast fluid, in concert with the transport fluid, having the energy necessary to discharge the particles out of the blast nozzle. In some versions, the venturi is integrated with the blast nozzle.

### BRIEF DESCRIPTION OF THE DRAWINGS

The accompanying drawings illustrate embodiments which serve to explain the principles of the present innovation.

FIG. 1 diagrammatically illustrates a particle blast system configured in accordance with one or more teachings of the present innovation.

FIG. 2 diagrammatically illustrates a particle blast system similar to that disclosed in FIG. 1 configured in accordance with one or more teachings of the present invention.

FIG. 3 is a side cross-sectional view of an embodiment of a flow mixer configured in accordance with one or more of the teachings of the present invention.

FIG. 4 a perspective cross-sectional view of the flow mixer of FIG. 3.

FIG. 5 is an enlarged fragmentary perspective cross-sectional view of the flow mixer of FIG. 3.

FIG. 6 is a perspective view of the flow mixer of FIG. 3, wherein the exit is visible.

FIG. 7 is an exploded view of the flow mixer of FIG. 3 illustrating the entrance end cap, the central housing and the exit end cap

FIG. 8 is a perspective view of the flow mixer of FIG. 3, wherein the entrance is visible, illustrating the shapes of the entrances of the first flow passageway and the second flow passageway.

FIG. 9 is a perspective view of the flow mixer of FIG. 3, wherein the entrance end cap is omitted, illustrating the shapes of the first flow passageway and the second flow passageway at the interface of the entrance cap and the central housing of the flow mixer.

FIG. 10 is a perspective cross-sectional view of the flow mixer of FIG. 3 taken along line 10-10 in FIG. 3, showing the shapes of the first flow passageway and the second flow passageway.

FIG. 11 is a perspective cross-sectional view of the flow mixer of FIG. 3 taken along line 11-11 in FIG. 3, showing the shapes of the first flow passageway and the second flow passageway at the indicated plane.

FIG. 12 is a perspective cross-sectional view of the flow mixer of FIG. 3 taken along line 12-12 in FIG. 3, showing the shapes of the first flow passageway and the second flow passageway at the indicated plane.

FIG. 13 is a perspective cross-sectional view of the flow mixer of FIG. 3 taken along line 13-13 in FIG. 3, showing the shapes of the first flow passageway and the second flow passageway and part of the vents which communicate with the second flow passageway.

FIG. 14 is a perspective cross-sectional view of the flow mixer of FIG. 3 taken along line 14-14 in FIG. 3, showing the shape of the combined flow passageway and part of the vents which communicate with the combined flow passageway.

FIG. 15 is a perspective cross-sectional view of the flow mixer of FIG. 3 taken along line in FIG. 3 showing the shape of the combined flow passageway along line 15-15.

FIG. 16 is an exploded view of the inserts of the flow mixer of FIG. 3 which form the first flow passageway and second flow passageway upstream and up to the intersection of the first flow passageway and the second flow passageway.

FIG. 17 is a perspective view of the upstream side of exit end cap 38.

FIG. 18 is a side cross-sectional view of another embodiment of a flow mixer configured in accordance with one or more of the teachings of the present invention.

FIG. 19 is an exploded view of the inserts of the flow mixer of FIG. 18 which form the combined flow path and blast nozzle.

### DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, one or more embodiments constructed according to the teachings of the present innovation are described.

It should be appreciated that with respect to any patent, publication, or other disclosure material, in whole or in part, that is said to be incorporated by reference herein, the disclosure as explicitly set forth herein supersedes any conflicting material incorporated herein by reference. Definitions, statements, or other disclosure material set forth in this disclosure shall supersede such material incorporated by reference to the extent necessary.

For clarity of disclosure, spatial terms such as “upstream,” “downstream,” “upper,” “outer,” “inner,” and “below,” are used herein for reference to relative positions and directions. Such terms are used below with reference to views as illustrated for clarity and are not intended to limit the innovation described herein.

The word “exemplary” is used herein to mean “serving as an example, instance, or illustration.” Any implementation described herein as “exemplary” is not necessarily to be construed as preferred or advantageous over other implementations.

In known prior art systems, the transport fluid is cooled by the cryogenic particles being conveyed. This cooling reduces the energy of the flow of transport fluid, which reduces the kinetic energy available to accelerate the particles out of the blast nozzle, and thus reduces the kinetic energy of the particles at impact. In systems that combine transport fluid flow with a flow of blast fluid, the cold transport fluid may significantly reduce the kinetic energy in the combined flow, reducing the kinetic energy available to accelerate the particles out of the blast nozzle, thus reducing the kinetic energy of the particles at impact.

Copending and co-owned U.S. patent application Ser. No. 17/139,292 for Method and Apparatus For Enhanced Blast Stream discloses the addition of energy to the entrained particle flow by combining a heated fluid flow with the flow of entrained particles. Even with the addition of the heated fluid flow, the cold transport fluid reduces the temperature of the combined flow, reducing the kinetic energy of particles and of the entraining fluid reaching the target. The reduced energy of the fluid, in the form of reduced temperature, means less thermal energy to heat and weaken the bonds between a coating or contaminant and the substrate.

Referring in more detail to the drawings, one or more embodiments constructed according to the teachings of the present innovation are described.

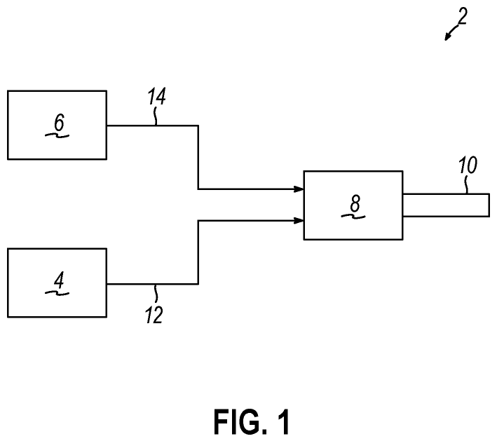

FIG. 1 diagrammatically illustrates a particle blast system 2 configured in accordance with one or more teachings of the present invention. In FIG. 1, particle blast system 2 comprises source of particles entrained in transport fluid 4, source of blast fluid 6, flow mixer 8 and blast nozzle 10. Particles entrained in transport fluid are conveyed/delivered to flow mixer 8 from source of particles entrained in transport fluid 4 as indicated by line 12 in FIG. 1. Particles entrained in transport fluid may be conveyed/delivered to flow mixer 8 via a hose, tube, or other conduit suitable to allow for conveyance/delivery of those particles entrained in transport fluid. Blast fluid is conveyed/delivered to flow mixer 8 from source of blast fluid 6 as indicated by line 14 in FIG. 1. Blast fluid may be conveyed/delivered to flow mixer 8 via a hose, tube, or other conduit suitable to allow for conveyance/delivery of the blast fluid. Source of particles entrained in transport fluid 4 may be any suitable source of particles entrained in transport fluid from which particles entrained in transport fluid may be conveyed/delivered to flow mixer 8. Source of blast fluid 6 may be any suitable source of blast fluid from which blast fluid may be conveyed/delivered to flow mixer 8. Blast nozzle 10 may be any suitable nozzle which is compatible with the system and its operating parameters. Blast nozzle 10 may be subsonic, sonic or supersonic.

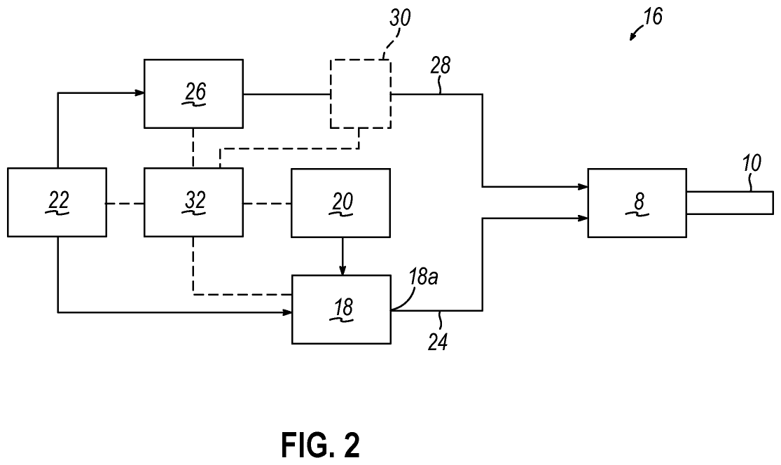

FIG. 2 diagrammatically illustrates a particle blast system 16 which is similar to particle blast system 2 of FIG. 1. In FIG. 2, particle feeder assembly 18 functions as a source of particles entrained in transport fluid. Particle feeder assembly 18 may be configured to receive particles from source of particles 20 and to receive transport fluid from source of fluid 22. Particle feeder assembly 18 may discharge at outlet 18a a flow of particles entrained in transport fluid which are conveyed/delivered to flow mixer 8 as indicated by line 24. The flow of particles entrained in transport fluid may be conveyed/delivered to flow mixer 8 via a hose, tube, or other conduit suitable to allow for conveyance/delivery of those particles entrained in transport fluid. Particle feeder assembly 18 may be of any suitable configuration which discharges particles entrained in transport fluid, such as, by way of non-limiting example, as disclosed in U.S. patent application Ser. No. 15/961,321. It may include a comminutor (not illustrated) configured to control/change the size of the particles, such as is disclosed in U.S. patent application Ser. No. 15/961,321, or such as is disclosed in U.S. patent application Ser. No. 15/297,967. The pressure of the transport fluid flowing with entrained particles through line 24 may be greater than atmospheric pressure, such as, by way of non-limiting example, the transport fluid with entrained particles that is discharged by the particle feeder assembly disclosed in U.S. patent application Ser. No. 15/961,321. Or the pressure of the transport fluid flowing with entrained particles through line 24 may be less than atmospheric pressure, such as, by way of non-limiting example, the transport fluid with entrained particles that is discharged by the particle feeder assembly disclosed in U.S. Pat. No. 6,024,304.

FIG. 2 illustrates heater 26 as a source of blast fluid which is conveyed to flow mixer 8 as indicated by line 28. The temperature of the blast fluid when it reaches flow mixer 8 or intersection 44 may be any suitable temperature, for example, about 750 degrees Fahrenheit. The temperature may be within a range of temperatures from above ambient up to and including about 750 degrees Fahrenheit, including but not limited to a range of about 150 degrees Fahrenheit to about 200 degrees Fahrenheit. Depending on the desired performance and the target, the temperature of the heated flow may be higher than about 750 degrees Fahrenheit, including but not limited to a range of about 750 degrees Fahrenheit to about 800 degrees Fahrenheit. In some embodiments, the blast fluid may be not heated. Blast fluid may be conveyed/delivered to flow mixer 8 via a hose, tube, or other conduit suitable to allow for conveyance/delivery of the blast fluid. Source of fluid 22 may be the source of fluid for heater 26, in which case source of fluid 22 may be characterized as a source of blast fluid. Particle blast system 16 may also comprise dryer 30 which may be configured and disposed to remove moisture from the blast fluid. The temperature of one or more of the transport fluid, the transport fluid with entrained particles, the blast fluid, or the combined fluid flow may be monitored and heater 26 may be controlled in response to such monitoring in order to optimize the temperature at the blast nozzle exit. Processing system 32, which may be microprocessor based or be of any suitable configuration, may be configured to control the temperature and flow rate of the heated blast fluid flow as well as the mass flow, particle size and flow rate of the flow of entrained particles.

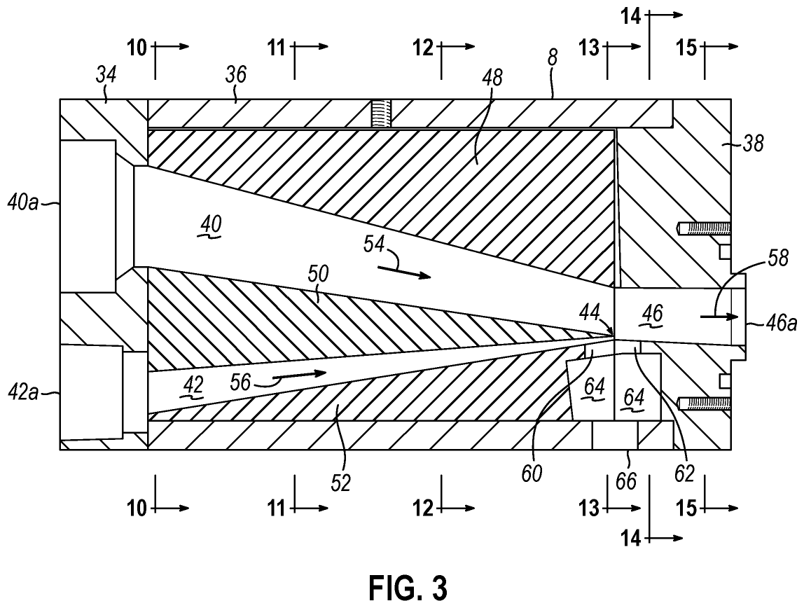

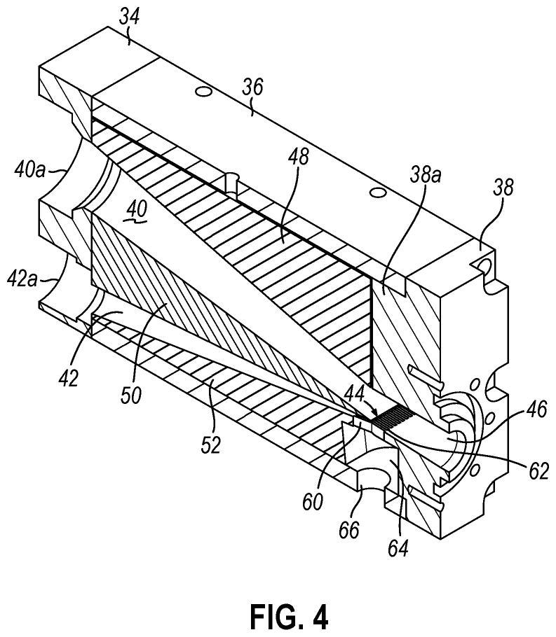

Referring to FIGS. 3 and 4, an exemplary embodiment of flow mixer 8 is illustrated in cross-section. Flow mixer 8 comprises entrance end cap 34, central housing 36 and exit end cap 38. Flow mixer 8 defines first flow passageway 40 and second flow passageway 42. Second flow passageway 42 intersects, in fluid communication, with first flow passageway 40 at intersection 44. The portion of first flow passageway 40 which extends downstream of intersection 44 may also be referred to as combined flow passageway 46. First flow passageway 40 may be disposed at an angle relative to combined flow passageway 46, although the scope of this disclosure is not limited thereto.

First flow passageway 40 includes inlet 40a and second flow passageway 42 includes inlet 42a. Entrance end cap 34 includes respective mounting configurations at inlet 40a and inlet 42a adapted to have the physical embodiments of lines 14 and 12 connected thereto.

Combined flow passageway 46 includes outlet or exit 46a. In the embodiment depicted, exit end cap 38 includes a mounting configuration at outlet 46a adapted to have blast nozzle 10 connected thereto. Alternatively, blast nozzle 10 may not be mounted directly to flow mixer 8.

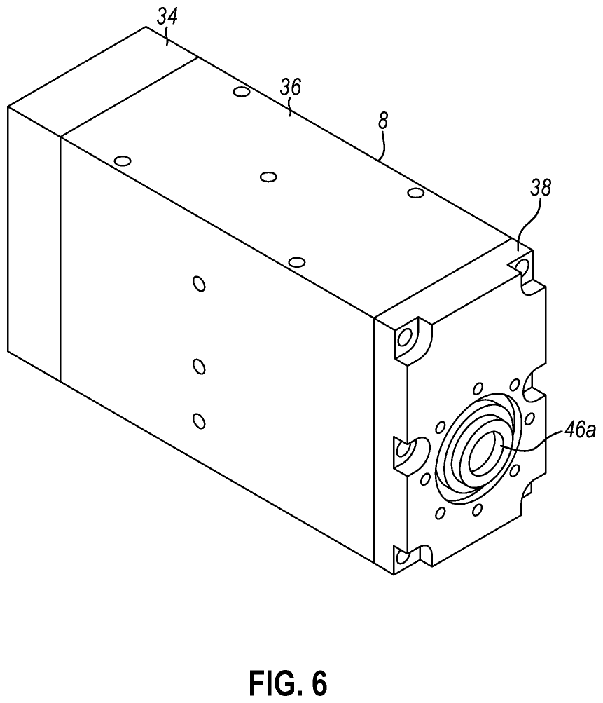

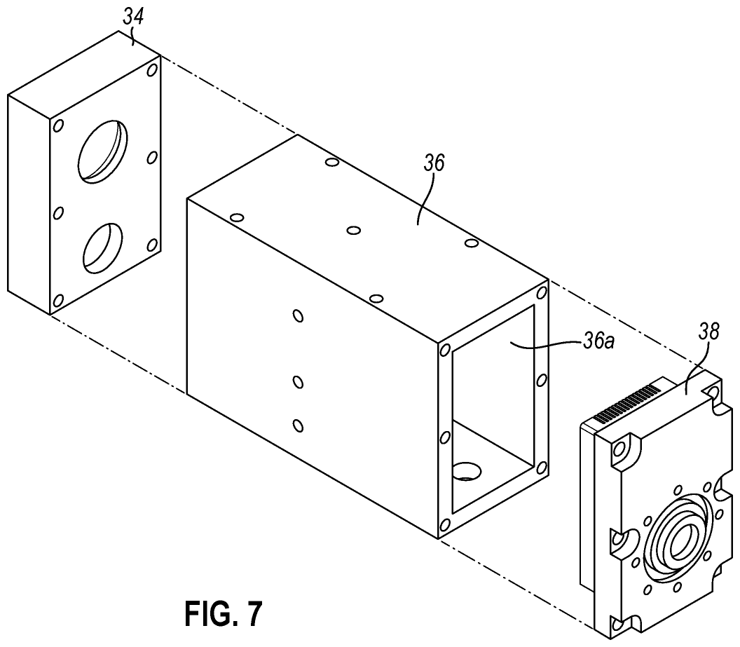

FIG. 6 is a perspective view of the depicted embodiment of flow mixer 8. FIG. 7 illustrates entrance end cap 34 and exit end cap 38 exploded from central housing 36, showing interior cavity 36a. As seen in FIGS. 3 and 4, in the embodiment depicted, first flow passageway 40 is defined by upper insert 48 and central insert 50 disposed in interior cavity 36a.

As can be seen at least in FIGS. 3 and 4, the cross-sectional area of first flow passageway 40 may decrease in the direction of flow (downstream), indicated by arrow 54. The cross-sectional area of second flow passageway 42 may decrease in the direction of flow (downstream), indicated by arrow 56. The cross-sectional area of combined flow passageway 46 may increase or may remain substantially constant in the direction of flow (downstream), indicated by arrow 58.

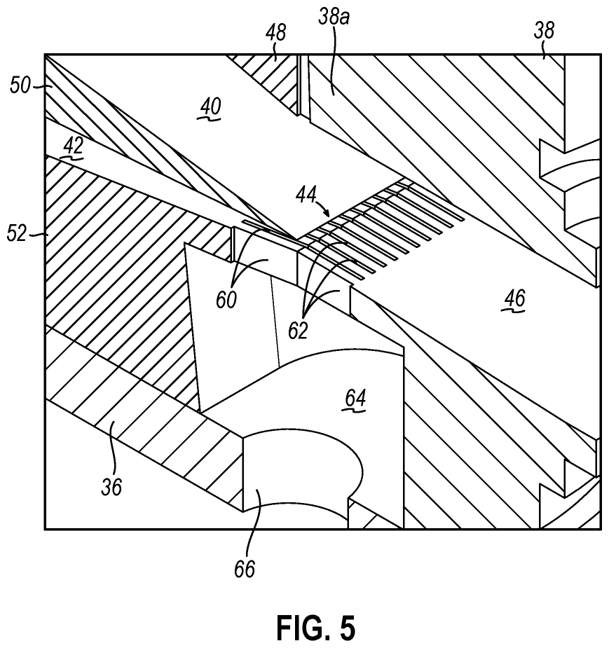

As seen in FIGS. 3, 4 and 5, second flow passageway 42 comprises a plurality of vents 60 extending in an upstream direction from intersection 44. As shown, vents 60 are in direct fluid communication with second flow passageway 42. As used herein, “direct fluid communication” means there are no intermediate components through which fluid may flow; correspondingly, “indirect fluid communication” means that at least one intermediate component may be located between two components said to be in fluid communication. Thus, as used herein, “fluid communication” refers to direct fluid communication or indirect fluid communication. Although in the depicted embodiment there is a plurality of vents 60, one or more vents may be used. Additionally, although in the depicted embodiment, vents 60 extend upstream from intersection 44, one or more vents 60 may be disposed at any position or positions along second flow passageway 42 sufficient to function in accordance with the teachings of the present invention to vent transport fluid from the flow of particles entrained in transport fluid, whether adjacent intersection 44 (as illustrated), proximal intersection 44, and/or at one or more positions further upstream from intersection 44. The number, length and width (also referred to herein as vent area or total vent area) may be such as is sufficient to in accordance with the teachings of the present invention to vent transport fluid from the flow of particles entrained in transport fluid. The width of vents 60 may be smaller than the anticipated smallest size of particles desired to be expelled out the blast nozzle so that those particles do not flow through vents 60.

In the embodiment depicted, combined flow passageway 46 comprises a plurality of vents 62 extending in a downstream direction from intersection 44. As shown, vents 62 are in direct fluid communication with the combined flow passageway 46. Although in the depicted embodiment there is a plurality of vents 62, one or more vents may be used, or vents 62 may be omitted entirely. Additionally, although in the depicted embodiment, vents 62 extend downstream from intersection 44, one or more vents 62 may be disposed at any position or positions along combined flow passageway 46 sufficient to function in accordance with the teachings of the present invention to vent transport fluid from the flow of particles entrained in transport fluid, whether adjacent intersection 44 (as illustrated), proximal intersection 44, and/or at one or positions further downstream from intersection 44. The number, length and width (also referred to here in as vent area or total vent area) may be such as is sufficient to in accordance with the teachings of the present invention to vent transport fluid from the flow of particles entrained in transport fluid. The width of vents 62 may be smaller than the anticipated smallest size of particles desired to be expelled out the blast nozzle so that those particles do not flow through vents 62.

Vents 60 place second flow passageway 42 in fluid communication with vent passageway 64. Vents 62 place combined flow passageway 46 in fluid communication with vent passageway 64. Vent passageway 64 comprises vent exit 66. Vent passageway 66 may be open to the ambient, as illustrated, may have a breathable sound attenuation device (not illustrated) or may be connected to a vent hose or conduit (not illustrated). Additionally, vent passageway 64 may be connected to a passageway having a lower pressure thereby suctioning transport fluid therethrough.

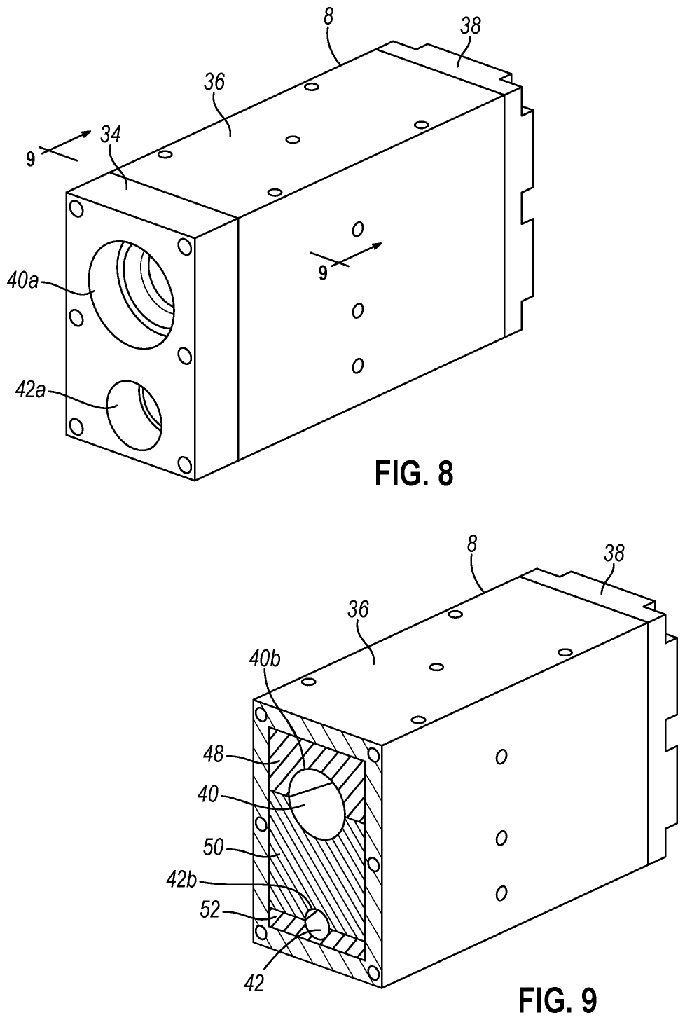

Referring to FIG. 8, flow mixer 8 is illustrated in a perspective view wherein inlets 40a and 42a are visible. FIG. 9 is similar to FIG. 8, with entrance end cap 34 omitted, revealing the entrances 40b, 42b to the portion of first and second flow passageways 40, 42 defined by upper insert 48, central insert 50 and lower insert 52. As is illustrated, in the embodiment depicted entrances 40b and 42b are circular, although any suitable cross-sectional shape may be used.

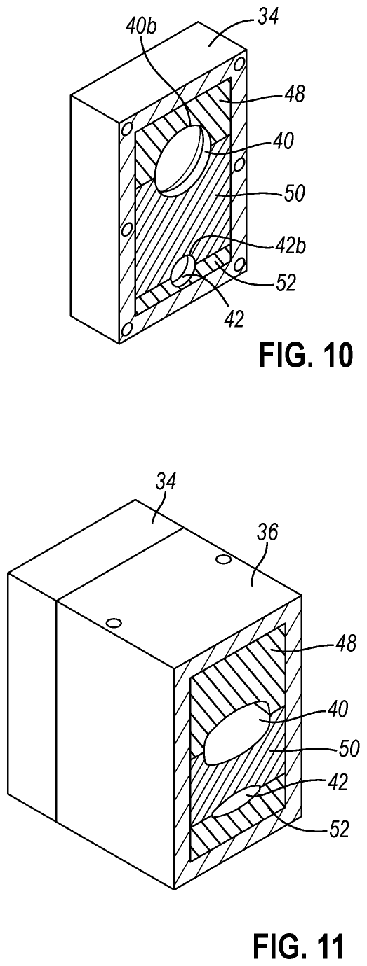

FIG. 10 is a perspective cross-sectional view taken along line 10-10 in FIG. 3. The generally circular shape of entrances 40b and 42b are visible. FIG. 11 is a perspective cross-sectional view of flow mixer 8 taken along line 11-11 in FIG. 3. In FIG. 11, the shape change of first flow passageway 40 and second flow passageway 42 progressing in the downstream direction can be seen. First flow passageway 40 transitions from its generally circular cross-sectional shape at entrance 40b, becoming flatter—having a smaller vertical dimension. Second flow passageway 42 transitions from its generally circular cross-sectional shape at entrance 42b becoming flatter and wider—having a smaller vertical dimension and a larger lateral dimension.

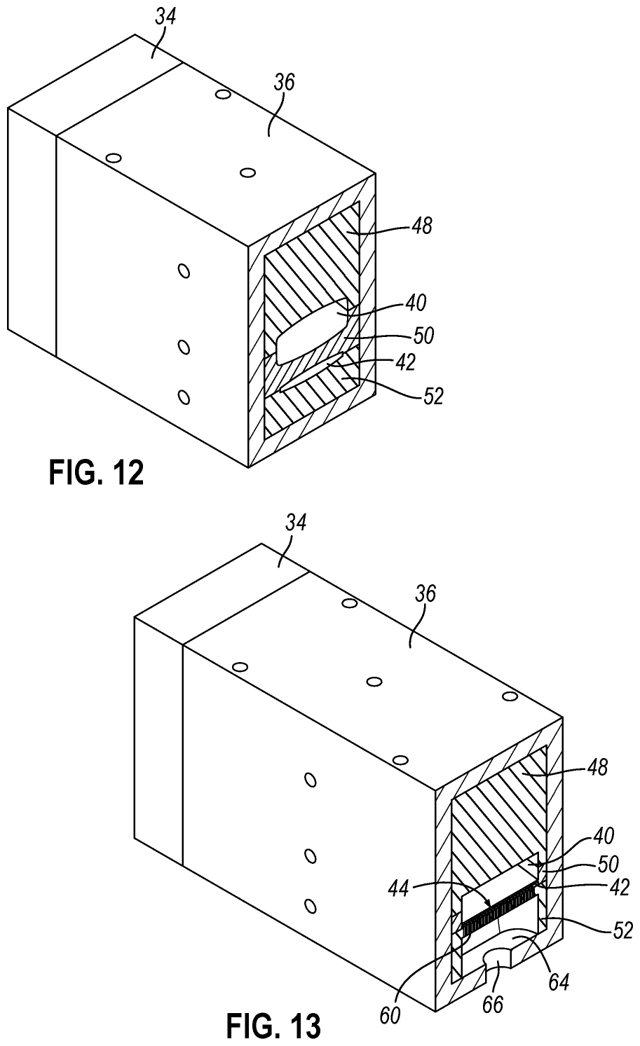

FIG. 12 is a perspective cross-sectional view of flow mixer 8 taken along line 12-12 in FIG. 3. In the depicted embodiment, the continuing shape change of first flow passageway 40 and second flow passageway 42 can be seen. The respective cross-sectional areas of first flow passageway 40 and second flow passageway 42 may decrease in the downstream direction up to a transition stopping point, such as, for example, intersection 44. At the transition stopping point the respective cross-sectional areas of first flow passageway 40 and second flow passageway 42 may stop decreasing.

FIG. 13 is a perspective cross-sectional view of flow mixer 8 taken along line 13-13 in FIG. 3. The downstream ends of upper insert 48, central insert 50 and lower insert 52, with vents 60, are visible.

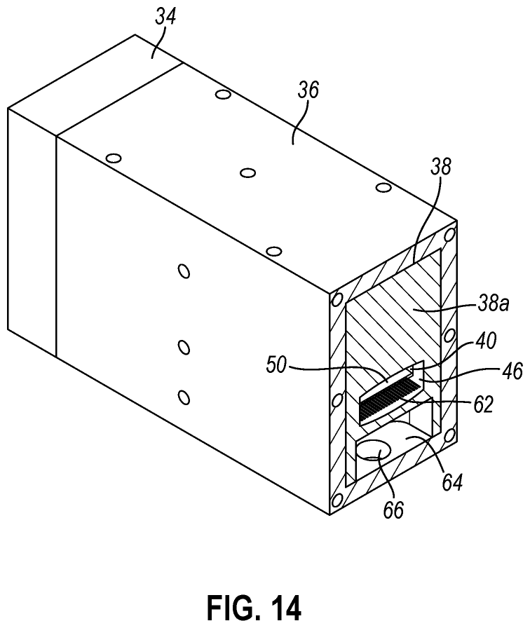

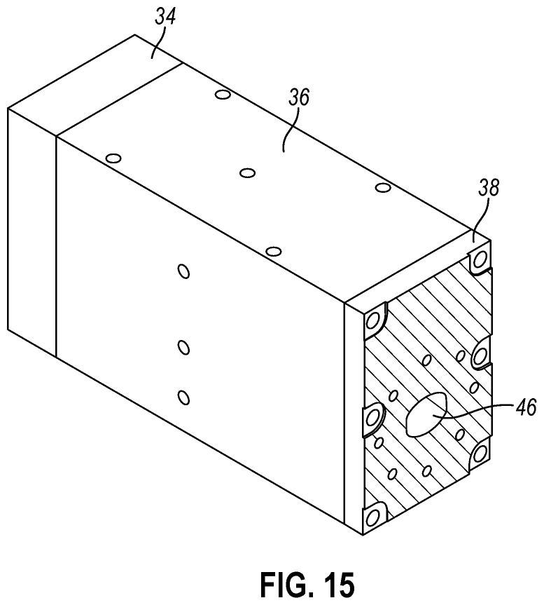

The cross-section visible in FIG. 14 is taken along line 14-14 in FIG. 3. At this location, the transition of the cross-sectional shape of combined flow passageway 46, which is defined by exit end cap 38, from the shape at intersection 44 can be seen. As seen in FIG. 15, a perspective cross-sectional view of flow mixer 8 taken along line 15-15 in FIG. 3, the transition of the cross-sectional shape of combined flow passageway 46 toward its generally circular cross-sectional shape at exit 46a (see FIG. 6) can be seen. The cross-sectional area of combined flow passageway 46 may increase or stay substantially constant in the downstream direction from intersection 44 to exit 46a.

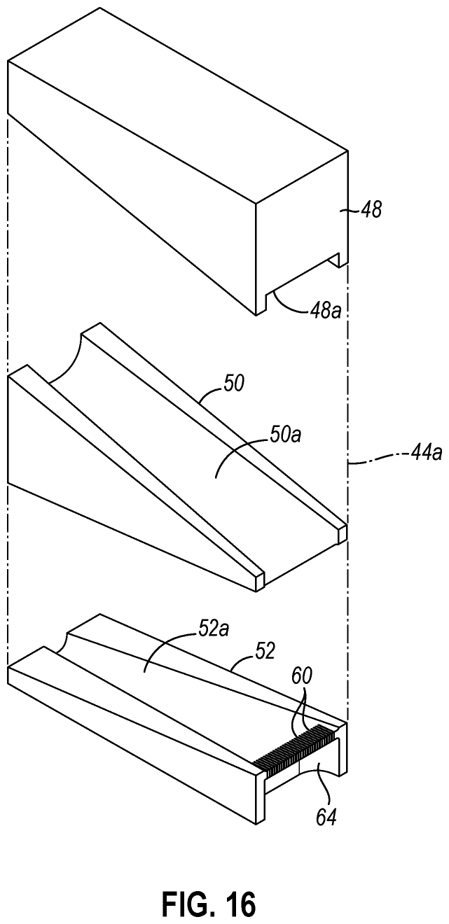

Referring to FIG. 16, there is shown an exploded view of upper insert 48, central insert 50 and lower insert 52, without central housing 36, entrance end cap 34 and exit end cap 38. The downstream end of these inserts are illustrated aligned at line 44a, which when assembled, coincides with intersection 44. Upper insert 48 comprises channel 48a which cooperates with channel 50a of central insert 50 to form first passageway 40. Central insert 50 comprises a channel on its lower surface (not visible in FIG. 16) which cooperates with channel 52a of lower insert 52 to form second passageway 42. In the depicted embodiment, vents 60 are formed in lower insert 52, overlying and fluidly communicating with vent passageway 64.

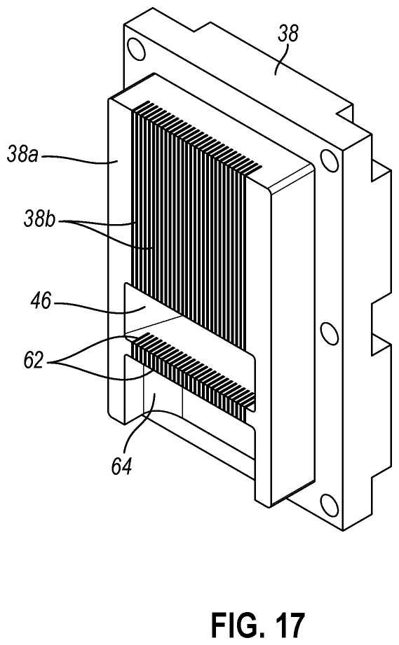

Referring to FIG. 17, there is illustrated a perspective view of exit end cap 38 showing upstream portion 38a which extends into internal cavity 36a. Upstream portion 38a comprises vents 62 and defines a portion of combined flow passageway 46. FIG. 17 also illustrates slots 38b disposed above combined flow passageway 46 which are aligned with vents 62. In the embodiment depicted, slots 38b are not vents, but are formed as part of the process to form vents 62.

In operation, a flow of blast fluid, typically air, may be directed through first flow passageway 40. As mentioned above, the energy of blast fluid flow may be increased such as by being heated, producing hot blast fluid such as, by way of non-limiting example, at the parameters described in U.S. patent application Ser. No. 17/139,292. A flow of particles entrained in transport fluid, typically air, may be directed through second flow passageway 42. The particles may comprise cryogenic particles, non-cryogenic particles, or mixed media particles. For cryogenic particles, such as, by way non-limiting example, carbon dioxide particles, the temperature and sublimation of the particles will affect the energy of the transport fluid, such as by decreasing the temperature. At intersection 44, operating within the design parameters, the pressures in the flow of blast fluid and in the flow of entrained particles are such that the particles will combine or merge with the flow of blast fluid and all or a sufficient or substantial portion of the transport fluid will pass through vents 60 and/or 62, into vent passageway 64 and out vent exit 66. The venting of the transport fluid prior to, proximal to or adjacent with the merging or introduction of the particles into the flow of blast fluid prevents or reduces the effect of the lower temperature (lower thermal energy) of the transport fluid on the energy, thermal and kinetic, of the blast fluid. As used herein, the term “vents” refers to structures that allow at least a portion of the transport fluid to be separated from the particles and/or the combined flow, depending on if the vents are located upstream or downstream of the intersection 44, without being recombined with the combined flow prior to the combined flow exiting the flow mixer or blast nozzle. As used herein, the term “design parameters” refers to operating conditions and/or values sufficient to allow the device to provide the desired performance.

As will be appreciated, the greater the volume of the flow of transport fluid that is vented (i.e., not present in/combined with the blast fluid flow), the less the effect the lower energy of the transport fluid will/can have on the energy of the blast fluid flow. Although desirable and within the scope of the teachings of the present invention, the teachings of the present invention do not require that all transport fluid be vented away before particles are entrained (combined/merged/introduced) into the flow of blast fluid.

In accordance with the many teachings of the present invention, the transport fluid flow is a flow fluid which has sufficient energy to transport the particles, entrained therein, into combination/merge/introduction into the flow of blast fluid. The blast fluid flow is a fluid flow which has sufficient energy, in conjunction with the effect of any transport fluid thereon, at the point of combination/merge/introduction to discharge the particles out the blast nozzle.

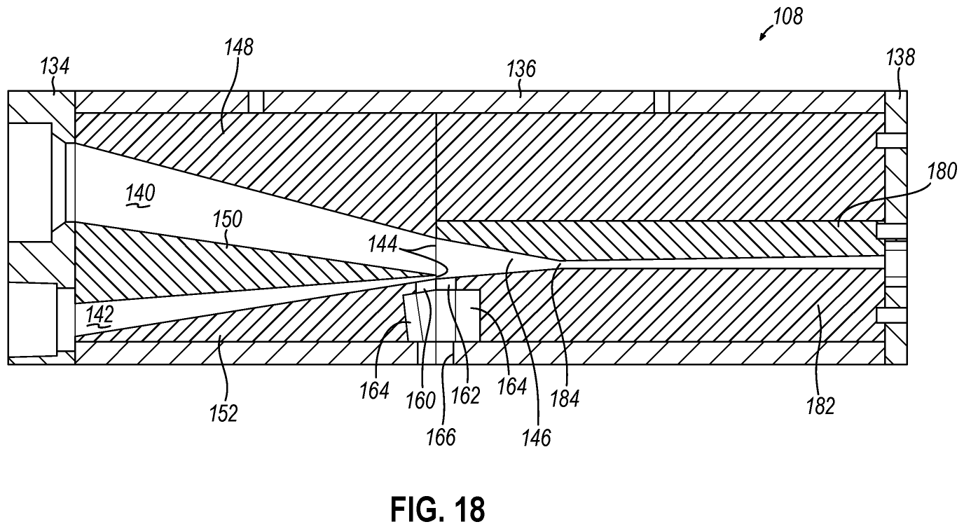

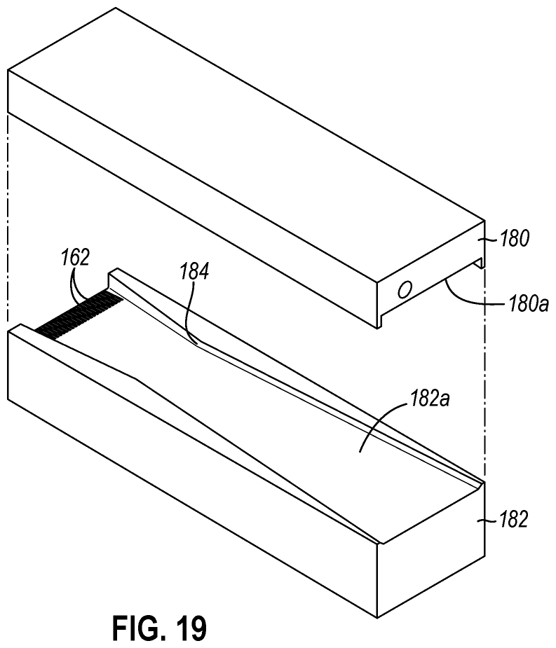

FIG. 18 illustrates an alternate embodiment of a flow mixer configured in accordance with one or more teachings of the present invention. Flow mixer 108 comprises entrance end cap 134, central housing 136 and exit end cap 138. Flow mixer 108 comprises first flow passageway 140, second flow passageway 142 and combined flow passageway 146. As shown in FIGS. 18 and 19, flow mixer 108 includes intersection 144, upper insert 148, central insert 150, lower insert 152, vents 160, vents 162, vent passageway 164, and vent exit 166, which are similar to the correspondingly named and numbered structures of flow mixer 8 described above.

The configuration, construction and operation of flow mixer 108 differs from that of flow mixer 8 above in that flow mixer 108 comprises an integral blast nozzle. In the embodiment depicted, combined flow passageway 146 is defined by central insert 180 and lower insert 182. Referring also to FIG. 19, central insert 180 comprises channel 180a which cooperates with channel 182a of lower insert 182 to form combined flow passageway 146 at the upstream end of inserts 180, 182 leading to a converging-diverging nozzle profile downstream thereof. The converging—diverging nozzle portion has throat 184 at which under the design parameters flow reaches Mach 1 and thereafter expands to supersonic flow.
Example 1: A method comprising the steps of providing a flow of blast fluid, transporting a periodically continuous flow of particles entrained in a transport fluid to a location proximal to the flow of blast fluid, separating the flow of particles from at least an effectual portion of the transport fluid, and thereafter introducing, combining or entraining the particles into the flow of blast fluid.
Example 2: The method of example 1, wherein the blast fluid has been heated.
Example 3: The method of example 1, wherein the blast fluid is at least 700 degrees Fahrenheit.
Example 4: The method of example 1, comprising directing the flow of blast fluid with entrained particles at a target workpiece.
Example 5: The method of example 4, comprising the step of increasing the speed of particles after they have been entrained into the flow of blast fluid prior to directing the flow of blast fluid with entrained particles at a target workpiece.
Example 6: The method of example 1, wherein the step of separating the flow of particles from the transport fluid comprises venting the transport fluid from the flow of particles entrained in the transport fluid.
Example 7: The method of example 1 wherein the step of separating the flow of particles from the transport fluid is carried out prior to entraining the particles into the flow of blast fluid.
Example 8: The method of example 1, wherein at least a portion of the step of separating the flow of particles from the transport fluid is carried out while the particles are being entrained into the flow of blast fluid.
Example 9: A flow mixer comprising a first flow passageway, a second flow passageway which intersects the first flow passageway at an intersection, a combined flow passageway in fluid communication with the first flow passageway and the second flow passageway at the intersection, one or more vents in direct fluid communication with the second flow passageway, the one or more vents disposed proximal the intersection.
Example 10. The flow mixer of example 9, wherein the one or more vents extend from the intersection in an upstream direction.
Example 11. The flow mixer of example 9, comprising one or more vents in direct fluid communication with the combined flow passageway, the one or more vents disposed proximal the intersection.
Example 12. The flow mixer of example 11, wherein the one or more vents in direct fluid communication with the combined flow passageway extend from the intersection in a downstream direction.

In accordance with various aspects of the disclosure, an element, or any portion of an element, or any combination of elements may be implemented with a “processing system” that includes one or more physical devices comprising processors. Non-limiting examples of processors include microprocessors, microcontrollers, digital signal processors (DSPs), field programmable gate arrays (FPGAs), programmable logic devices (PLDs), programmable logic controllers (PLCs), state machines, gated logic, discrete hardware circuits, and other suitable hardware configured to perform the various functionality described throughout this disclosure. One or more processors in the processing system may execute processor-executable instructions. A processing system that executes instructions to effect a result is a processing system which is configured to perform tasks causing the result, such as by providing instructions to one or more components of the processing system which would cause those components to perform acts which, either on their own or in combination with other acts performed by other components of the processing system would cause the result. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. Computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Explicit Definitions

“Based on” means that something is determined at least in part by the thing that it is indicated as being “based on.” When something is completely determined by a thing, it will be described as being “based exclusively on” the thing.

“Processor” means devices which can be configured to perform the various functionality set forth in this disclosure, either individually or in combination with other devices. Examples of “processors” include microprocessors, microcontrollers, digital signal processors (DSPs), field programmable gate arrays (FPGAs), programmable logic devices (PLDs), programmable logic controllers (PLCs), state machines, gated logic, and discrete hardware circuits. The phrase “processing system” is used to refer to one or more processors, which may be included in a single device, or distributed among multiple physical devices.

A statement that a processing system is “configured” to perform one or more acts means that the processing system includes data (which may include instructions) which can be used in performing the specific acts the processing system is “configured” to do. For example, in the case of a computer (a type of “processing system”) installing Microsoft WORD on a computer “configures” that computer to function as a word processor, which it does using the instructions for Microsoft WORD in combination with other inputs, such as an operating system, and various peripherals (e.g., a keyboard, monitor, etc.).

The foregoing description of one or more embodiments of the innovation has been presented for purposes of illustration and description. It is not intended to be exhaustive or to limit the invention to the precise form disclosed. Obvious modifications or variations are possible in light of the above teachings. The embodiments were chosen and described in order to best illustrate the principles of the innovation and its practical application to thereby enable one of ordinary skill in the art to best utilize the innovation in various embodiments and with various modifications as are suited to the particular use contemplated. Although only a limited number of embodiments of the innovation is explained in detail, it is to be understood that the innovation is not limited in its scope to the details of construction and arrangement of components set forth in the preceding description or illustrated in the drawings. The innovation is capable of other embodiments and of being practiced or carried out in various ways. Also, specific terminology was used for the sake of clarity. It is to be understood that each specific term includes all technical equivalents which operate in a similar manner to accomplish a similar purpose. It is intended that the scope of the invention be defined by the claims submitted herewith.

1. A flow mixer comprising:
a. a first flow passageway;
b. a second flow passageway which intersects with the first flow passageway at an intersection;
c. a combined flow passageway in fluid communication with the first flow passageway and the second flow passageway at the intersection; and
d. one or more second passageway vents in direct fluid communication with the second flow passageway.

2. The flow mixer of claim 1, wherein the one or more second passageway vents are disposed adjacent to the intersection.

3. The flow mixer of claim 1, wherein the one or more second passageway vents extend in an upstream direction.

4. The flow mixer of claim 1, wherein the one or more second passageway vents extend from the intersection in an upstream direction.

5. The flow mixer of claim 1, further comprising one or more combined flow passageway vents in direct fluid communication with the combined flow passageway.

6. The flow mixer of claim 5, wherein the one or more combined flow passageway vents are disposed adjacent to the intersection.

7. The flow mixer of claim 5, wherein the combined flow passageway vents extend in a downstream direction.

8. The flow mixer of claim 5, wherein the combined flow passageway vents extend from the intersection in a downstream direction.

9. The flow mixer of claim 5, wherein the one or more second passageway vents are in direct fluid communication with the one or more combined flow passageway vents.

10. The flow mixer of claim 1, wherein the one or more second passageway vents are in fluid communication with a vent passageway.

11. The flow mixer of claim 10, further comprising one or more combined flow passageway vents in direct fluid communication with the combined flow passageway, wherein the combined flow passageway vents are in fluid communication with the vent passageway.

12. The flow mixer of claim 10, wherein the vent passageway comprises a vent exit and the vent exit is defined by an external surface of the flow mixer.

13. The flow mixer of claim 1, wherein the first passageway comprises a first passageway entrance and a first passageway cross-sectional area, wherein the first passageway cross-sectional area decreases as the first passageway extends from the first passageway entrance toward a first passageway transition stopping point.

14. The flow mixer of claim 13, wherein the first passageway transition stopping point is the intersection.

15. The flow mixer of claim 13, wherein the first passageway cross-sectional area decreases continuously as the as the first passageway extends from the first passageway entrance toward the first passageway transition stopping point.

16. The flow mixer of claim 1, wherein the second passageway comprises a second passageway entrance and a second passageway cross-sectional area, wherein the second passageway cross-sectional area decreases as the second passageway extends from the second passageway entrance toward a second passageway transition stopping point.

17. The flow mixer of claim 16, wherein the second passageway transition stopping point is the intersection.

18. The flow mixer of claim 16, wherein the second passageway cross-sectional area decreases continuously as the second passageway extends from the second passageway entrance toward the second passageway transition stopping point.

19. The flow mixer of claim 1, wherein the first passageway comprises a first passageway entrance and a first passageway vertical dimension, wherein the first passageway vertical dimension decreases as the first passageway extends from the first passageway entrance toward a first passageway transition stopping point.

20. The flow mixer of claim 1, wherein the second passageway comprises a second passageway entrance and a second passageway vertical dimension, wherein the second passageway vertical dimension decreases as the second passageway extends from the second passageway entrance toward a second passageway transition stopping point.

21. The flow mixer of claim 1, wherein the second passageway comprises a second passageway entrance and a second passageway lateral dimension, wherein the second passageway lateral dimension increases as the second passageway extends from the second passageway entrance toward a second passageway transition stopping point.

22. The flow mixer of claim 1, wherein the combined flow passageway comprises a combined flow passageway exit and a combined flow passageway cross-sectional area, wherein the combined flow passageway cross-sectional area increases as the combined flow passageway extends from the intersection toward the combined flow passageway exit.

23. The flow mixer of claim 22, wherein the combined flow passageway cross-sectional area increases continuously as the combined flow passageway extends from the intersection toward the combined flow passageway exit.

24. An assembly comprising
a. the flow mixer of claim 1; and
b. a blast nozzle, wherein the blast nozzle is in fluid communication with the combined flow passageway.

25. The assembly of claim 24, wherein the blast nozzle is integral with the flow mixer.

26. A flow mixer comprising:
a. an upper insert comprising an upper insert channel;
b. a central insert comprising a first central insert channel and a second central insert channel, wherein the first central insert channel and the upper insert channel define a first fluid passageway;
c. a lower insert comprising a lower insert channel, wherein the second central insert channel and the lower insert channel define a second flow passageway which intersects with the first flow passageway at an intersection; and
d. one or more second passageway vents formed in the lower insert in direct fluid communication with the second flow passageway.

27. The flow mixer of claim 26, further comprising a combined flow passageway in fluid communication with the first flow passageway and the second flow passageway at the intersection.

28. The flow mixer of claim 27, further comprising one or more combined flow passageway vents in direct fluid communication with the combined flow passageway.

29. The flow mixer of claim 26, further comprising a central nozzle insert and lower nozzle insert, wherein the central nozzle insert comprises a central nozzle insert channel and the lower nozzle insert comprises a lower nozzle insert channel, wherein a combined flow passageway is defined by the central nozzle insert channel and the lower nozzle insert channel.

30. The flow mixer of claim 29, wherein the combined flow passageway comprises a throat, wherein the combined flow passageway comprises a converging portion upstream of the throat and a diverging portion downstream of the throat.

31. The flow mixer of claim 26, wherein the one or more second passageway vents are in fluid communication with a vent passageway.

32. The flow mixer of claim 31, wherein the vent passageway comprises a vent exit and the vent exit is defined by an external surface of the flow mixer.

33. A method of expelling a stream of entrained particles from a blast nozzle, comprising:
a. providing a flow of blast fluid;
b. providing a flow of entrained particles, wherein the flow of entrained particles comprises a transport fluid and a plurality of particles entrained within the transport fluid;
c. separating at least a portion of the transport fluid in the flow of entrained particles from the plurality of particles in the flow of entrained particles, thereby creating a vented flow comprising the transport fluid that is separated from the plurality of particles;
d. creating a combined flow by combining the flow of blast fluid with the plurality of particles in the flow of entrained particles;
e. flowing the combined flow through and out of a blast nozzle; wherein the vented flow remains separated from the combined flow exiting the blast nozzle.

34. The method of claim 33, wherein the plurality of particles comprises cryogenic particles.

35. The method of claim 33, wherein the blast fluid comprises heated fluid.

36. The method of claim 33, wherein the step of separating at least a portion of the transport fluid in the flow of entrained particles occurs before the step of creating a combined flow.

37. The method of claim 33, wherein the step of separating at least a portion of the transport fluid in the flow of entrained particles occurs after the step of creating a combined flow.

38. A flow mixer comprising:
a. a first flow passageway;
b. a second flow passageway which intersects with the first flow passageway at an intersection, wherein the second passageway comprises a second passageway entrance, a second passageway vertical dimension, and a second passageway lateral dimension, wherein the second passageway vertical dimension decreases as the second passageway extends from the second passageway entrance toward a second passageway transition stopping point and the second passageway lateral dimension increases as the second passageway extends from the second passageway entrance toward the second passageway transition stopping point; and
c. a combined flow passageway in fluid communication with the first flow passageway and the second flow passageway at the intersection.

39. The flow mixer of claim 38, wherein the vertical dimension of the second passageway decreases continuously as the as the second passageway extends from the second passageway entrance toward the second passageway transition stopping point.

40. The flow mixer of claim 38, wherein the lateral dimension of the second passageway decreases continuously as the second passageway extends from the second passageway entrance toward the first passageway transition stopping point.

41. The flow mixer of claim 38, wherein the second passageway transition stopping point is the intersection.

42. The flow mixer of claim 38, further comprising one or more second passageway vents in direct fluid communication with the second flow passageway.

43. The flow mixer of claim 38, wherein the first passageway comprises a first passageway entrance and a first passageway vertical dimension, wherein the first passageway vertical dimension decreases as the first passageway extends from the first passageway entrance toward a first passageway transition stopping point.

44. The flow mixer of claim 43, wherein the vertical dimension of the first passageway decreases continuously as the first passageway extends from the first passageway entrance toward the first passageway transition stopping point.

45. The flow mixer of claim 43, wherein the first passageway transition stopping point is the intersection.

46. The flow mixer of claim 38, wherein the second flow passageway is configured to be connected to a flow of entrained particles, wherein the flow of entrained particles comprises a transport fluid and a plurality of particles entrained within the transport fluid.

47. The flow mixer of claim 46, wherein the first flow passageway is configured to be connected to a flow of blast fluid.

48. The flow mixer of claim 47, wherein the best blast fluid comprises heated fluid.
